(19) United States
(12) Patent Application Publication
(10) Pub. No.: US 2005/0183526 A1
(43) Pub. Date: Aug. 25, 2005

(54) Ball screw apparatus

(75) Inventor: Takayuki Yabe, Gunma (JP)

Correspondence Address: SUGHRUE MION, PLLC, 2100 PENNSYLVANIA AVENUE, N.W., SUITE 800, WASHINGTON, DC, 20037, US

(73) Assignee: NSK Ltd. & NSK Precision Co., Ltd.

(21) Appl. No.: 11/046,901

(22) Filed: Feb. 1, 2005

(30) Foreign Application Priority Data
Feb. 2, 2004 (JP) P.2004-026137

(51) Int. Cl. F16H 29/20; F16H 29/02; F16H 27/02; F16H 3/06

(52) U.S. Cl. 74/89.44

(57) ABSTRACT

A ball screw apparatus has a screw shaft having an outer peripheral surface on which a shaft track groove is formed, a nut moving along with the screw shaft and having front and back end portions and an inner peripheral surface on which a nut track groove is formed and a contact-type seal member provided on each of the front and back end portions of the nut, a groove sliding contact portion is provided on the seal member sliding contacting with the shaft track groove. A first sealing lip is formed on a first outer peripheral of the groove sliding contact portion so as to sliding contact with a first inner surface of the shaft track groove which is defined between a groove bottom center thereof and an edge thereof which is located on a front-side of the moving direction of the nut.

The present invention claims foreign priority to Japanese patent application no. P.2004-026137, filed on February 2, the contents of which is incorporated herein by reference.

### BACKGROUND OF THE INVENTION

1. Field of the Invention

The present invention relates to a ball screw apparatus to be used in a feeding mechanism or the like for moving machinery such as a machine tool or a precision instrument.

2. Description of the Related Art

A ball screw apparatus of the related art (e.g., Japanese Patent Unexamined Publication JP-A-2003-343685) is constructed such that a shaft track groove formed helically in the outer peripheral of a grooved shaft and a nut track groove formed in the inner peripheral of a nut to confront the shaft track groove are screwed together through a plurality of balls. The ball screw-apparatus thus constructed is provided with seal mounting grooves at front and back end portions in the moving direction of the nut. Sealing member, which sliding contacts with the screw shaft, is mounted in the seal mounting grooves to form a contact-type seal so as to seal up an inside and an outside of the ball screw apparatus.

In the aforementioned related art, however, sliding contact portions of the seal members to make sliding contact with the grooved shaft are formed to make homogeneous contact with the-grooved shaft. If contact margins of the sliding contact portions are made large, the sliding resistances by the sliding contact portions are increased. If the sliding contact margins are made small to moderate the sliding resistances, the dust-resistance of the shaft track groove cannot be maintained. This occurs a problem that the reduction in the sliding resistances and the dust-resistance are difficult to be compatible.

### SUMMARY OF THE INVENTION

The present invention has been conceived to solve the aforementioned problem. An object of the present invention is to enhance the dust-resistance of a ball screw apparatus while maintaining the sliding resistance properly by a seal member of the ball screw apparatus.

In order to achieve the above-specified object, according to the present invention, there is provided a ball screw apparatus comprising:

a screw shaft having an outer peripheral surface on which a shaft track groove is formed so as to helically extend along with a longitudinal direction thereof;

a nut being capable of moving along with the screw shaft, the nut having front and back end portions and an inner peripheral surface on which a nut track groove is formed so as to oppose to the shaft track groove; and

a seal member provided on each of the front and back end portions of the nut, the seal member including:
a substantially arc-shaped groove sliding contact portion provided on the seal member so as to sliding contact with the shaft track groove, the groove sliding contact portion having:
   a first sealing lip formed on a first outer peripheral of the groove sliding contact portion so as to sliding contact with a first inner surface of the shaft track groove which is defined between a groove bottom center of the shaft track groove and an edge of the shaft track groove which is located on a front-side of the moving direction of the nut

wherein the first sealing lip projects to a screw shaft side rather than the groove sliding contact portion.

According to a second aspect of the present invention as set forth in the first aspect of the present invention, it is preferable that a second sealing lip is formed on a back-side peripheral of the groove sliding contact portion so as to contact with a second inner surface of the shaft track groove which is defined between a groove bottom center of the shaft track groove and an edge of the shaft track groove which is located on a back-side of the moving direction of the nut.

According to a third aspect of the present invention as set forth in the first aspect of the present invention, it is more preferable that the sealing member including:

an outer peripheral surface sliding contact portion which contacts with an outer peripheral surface of the screw shaft.

According to a fourth aspect of the present invention as set forth in the first aspect of the present invention, it is further preferable that a substantially entire side surface of the sealing lip sliding contacts with the shaft track groove.

According to a fifth aspect of the present invention as set forth in the first aspect of the present invention, it is furthermore preferable that the shaft track groove is substantially arc shaped in a sectional view.

According to a sixth aspect of the present invention as set forth in the first aspect of the present invention, it is suitable that the groove sliding contact portion is substantially arc shaped.

According to a seventh aspect of the present invention as set forth in the first aspect of the present invention, it is more suitable that the sealing lip is substantially arc shaped.

According to an eighth aspect of the present invention as set forth in the first aspect of the present invention, it is further suitable that the seal member is disposed perpendicular to a longitudinal axis of the screw shaft.

According to a ninth aspect of the present invention as set forth in the first aspect of the present invention, it is furthermore suitable that the seal member is made of elastic material.

According to a tenth aspect of the present invention as set forth in the second aspect of the present invention, it is preferable that the first sealing lip bends backwardly, and

the second sealing lip bends forwardly.

According to an eleventh aspect of the present invention as set forth in the second aspect of the present invention, it is more preferable that the first and second sealing lips bend in opposite direction mutually.

Thus, the present invention can make the seal members into the flake-like members thereby to form wide contact areas on the groove sliding contact portion on the arc face side. As a result, the invention can achieve the effects that it can prevent the intrusion of dust from the outside, and that it can keep the sliding resistance properly by the sealing portion while suppressing the sliding resistance substantially equivalent to the sliding resistance by the groove sliding contact portion.

Note that the front and back direction is defined by the moving direction of the nut.

### BRIEF DESCRIPTION OF THE DRAWINGS

FIG. 1 is a sectional and side elevational view showing a ball screw apparatus of Embodiment 1;

FIG. 2 is a view showing a seal member of Embodiment 1 and taken in the direction of arrow A of FIG. 1;

FIG. 3 is an explanatory view showing a sliding contact state of a groove sliding contact portion of the seal member on the front side of the moving direction of Embodiment 1;

FIG. 4 is a view showing a seal member of Embodiment 2 and taken in the direction of arrow A; and

FIG. 5 is an explanatory view showing a sliding contact state of a groove sliding contact portion of the seal member on the front side of the moving direction of Embodiment 2.

### DETAILED DESCRIPTION OF THE PREFERRED EMBODIMENTS

Embodiments of the ball screw apparatus according to the present invention will be described with reference to the accompanying drawings.

[Embodiment 1]

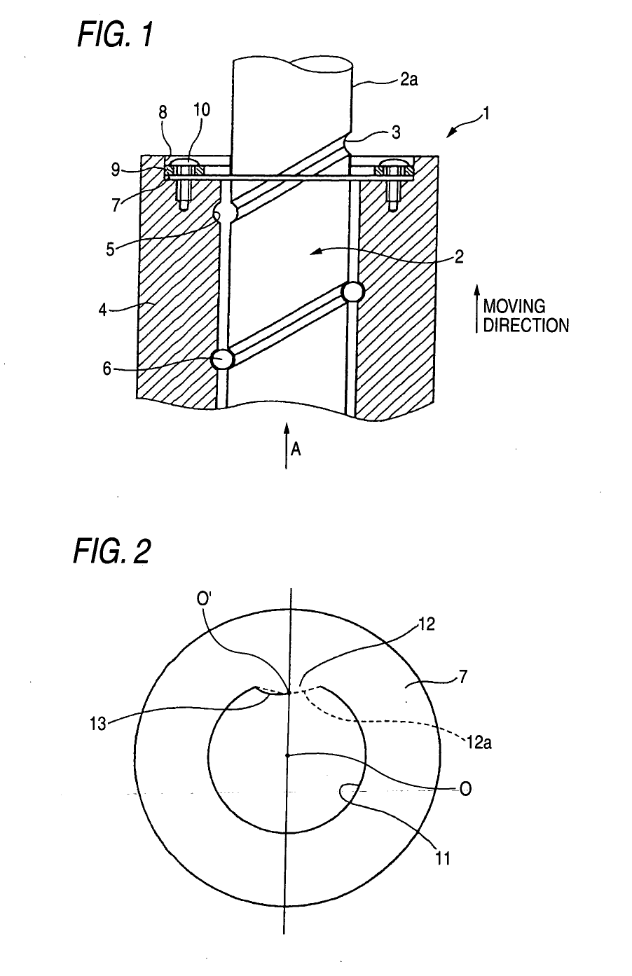

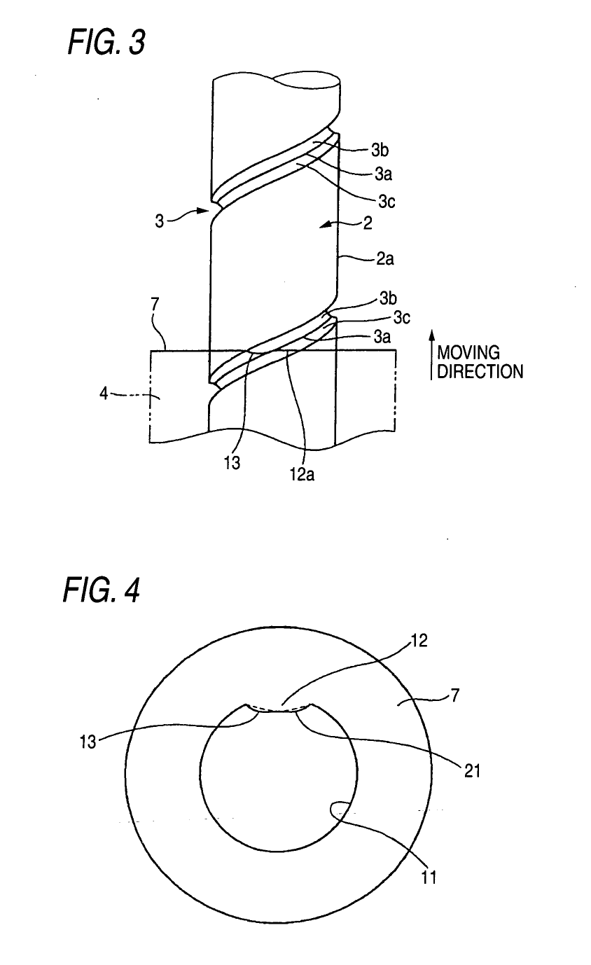

FIG. 1 is a sectional and side elevational view showing a ball screw apparatus of Embodiment 1; FIG. 2 is a view showing a seal member of Embodiment 1 and taken in the direction of arrow A of FIG. 1; and FIG. 3 is an explanatory view showing a sliding contact state of a groove sliding contact portion of the seal member on the front side of the moving direction of Embodiment 1.

In FIG. 1, numeral 1 designates a ball screw apparatus, which uses a return tube type circulation method in this embodiment.

Numeral 2 designates a grooved shaft of the ball screw apparatus. The grooved shaft 2 is made of a steel material such as alloy steel or carbon steel and is provided in its outer peripheral with a shaft track groove 3, which is so formed helically with a predetermined lead as to have a substantially semi-arc surface in a sectional view.

Numeral 4 designates a nut of the ball screw apparatus 1. The nut 4 is made of a steel material such as alloy steel or carbon steel and is provided in its inner peripheral with a shaft track groove 5, which is so formed with the same lead as that of the shaft track groove 3 as to confront the shaft track groove 3.

Numeral 6 designates balls, which are made of either steel material such as alloy steel or ceramic material. The plural balls 6 are fitted between the shaft track groove 3 and the nut track groove 5.

Numeral 7 designates a seal member, which is made of an elastic material such as natural rubber or synthetic rubber. The seal member 7 is mounted on a seal mounting portion 8, which is provided at each of the front and back end portions of the moving directions of the nut 4, through a reinforcing plate 9 by means of stop screws 10, thereby construct a contact type seal.

In FIG. 1, the seal member 7 is not shown in sectional view, alternatively, it is shown its substance for explanations.

The plural balls 6 and a lubricant or grease of a predetermined quantity are confined in the space between the shaft track groove 3 of the grooved shaft 2 and the confronting nut track groove 5 of the nut 4.

As a results the shaft track groove 3 and the nut track groove 5 are threaded by the balls 6. By turning the grooved shaft 2, the nut 4 is moved in the axial direction such that the balls 6 circulate in the circulation passage, which is formed by the not-shown return tube. The seal members 7 arranged at the front and back end portions of the moving direction, come into sliding contact with the outer peripheral 2a and the shaft track groove 3 of the grooved shaft 2 to seal up the clearance between the nut 4 and the grooved shaft 2 thereby to prevent the lubricant from leaking from the inside and the dust from intruding from the outside.

In FIG. 2, numeral 11 designates an outer peripheral sliding contact portion of the seal member 7. At the sliding contact portion 11, the seal member 7 comes into sliding contact with the outer peripheral 2a of the grooved shaft 2. In order to form a contact seal having a moderate sliding resistance, proper outer peripheral contact margin is set in outer peripheral sliding contact portion. That is, a half of the difference between the external diameter of the grooved shaft 2 and the internal diameter of the outer peripheral sliding contact portion 11 is set for the outer peripheral contact margin.

Numeral 12 designates a groove sliding contact portion of the seal member 7. The groove sliding contact portion 12 is a substantially semi-arc protrusion, as indicated by a broken curve in FIG. 2. The groove sliding contact portion 12 extends along a sectional shape of the shaft track groove 3 in a direction perpendicular to a longitudinal axis of the shaft track groove 3, and has a groove contact margin equivalent to the outer peripheral contact margin.

Numeral 13 designates a sealing lip formed on the groove sliding contact portion 12. The sealing lip 13 is a substantially arc flake member. The sealing lip 13 is formed on the groove sliding contact portion 12 on a side which sliding contact with a front arc-shaped surface 3b of the shaft track groove 3 which is located front side of a moving direction of the nut 4 in respect to a groove bottom center 3a of the shaft track groove 3 as shown in FIG. 3.

Thus, the groove sliding contact portion 12 of the embodiment is divided into halves across the groove bottom center 3a of the shaft track groove 3, as shown in FIG. 3. The sealing lip 13 is formed on the groove sliding contact portion 12 on the side which sliding contacts with the front arc surface 3b.

As a result, when the nut 4, which is indicated by double-dotted lines in FIG. 3, is screwed on the grooved shaft 2, the sealing lip 13 is bent along a slope of the front arc surface 3b toward the nut 4. That is, the sealing lip bends backward of the moving direction so that its entire side surface, which opposing to the shaft track groove 3, comes into sliding contact with the front arc surface 3b.

On the other hand, a back arc surface 3c is formed in the shaft track groove 3 on the opposite side of the front arc surface 3b across the groove bottom center 3a and is positioned at the back of the moving direction of the nut 4. The residual half, which is called one-side end portion 12a, of the groove sliding contact portion 12 on a side that the sealing lip 13 is not formed, is bent in the opposite direction of the nut 4, (i.e., in the moving direction) along the slope of the back arc surface 13c. At this time, the one-side end portion 12a is brought into sliding contact with the back arc surface 3c by the groove contact margin.

In other words, the seal lip 13 projects to the screw shaft side rather than a virtual circumference of the arc-shaped groove sliding contact portion 12. That is, when the groove sliding contact portion 12 is divided by a line passing through a center of the seal member O and a center of the groove sliding contact portion O′, a contact margin of a part of the groove sliding contact portion 12 having the seal lip 13 (left part of the seal member in FIG. 2) is larger than that of the residual part of the groove sliding contact portion 12 (right part of the seal member in FIG. 2).

Here, the one-side end portion 12a is indicated by broken curve in FIG. 2 for explanations. However, the one-side end portion 12a is a substance member. FIG. 3 shows the sliding contact state of the groove sliding contact portion 12 of the seal member 7 mounted on the front of the moving direction of the nut 4, i.e., on the front end portion of the nut 4. On the other hand, the seal member 7 mounted on the back of the moving direction of the nut 4, i.e., on the back end portion of the nut 4, takes a sliding contact state like the aforementioned one, when it reversely moves with the rear end portion of the nut 4 being positioned as the front end portion, i.e., with the back arc surface 3c shown in FIG. 3 being the front arc surface and with the front arc surface 3b being the back arc surface.

Therefore, the seal member 7 of the front end portion and the seal member 7 of the rear end portion are prepared in a mirror image. If the seal member 7 is longitudinally symmetric in the thickness direction in this case, it may be turned upside down when mounted on the back end portion by the stop screws 10.

The actions of the construction thus far described are explained in the following.

The nut 4 having the seal members 7 of the embodiment mounted thereon is screwed on the grooved shaft 2 through the balls 6. When the nut 4 is moved, in a front side of the moving direction (i.e., the groove sliding contact portion of the seal member 7 which is mounted a front side of the nut 4), the one-side end portion 12a of the groove sliding contact portion 12 is bent in the moving direction of the nut 4 while sliding contacting with the back arc surface 3c by the groove contact margin.

Further, the sealing lip 13 is bent backward of the moving direction of the nut 4 and moves in the moving direction while its entire side face on the side of the shaft track groove 3 sliding contacting with the front arc surface 3b.

At this time, the one-side end portion 12a of the groove sliding contact portion 12 is bent in the moving direction of the nut 4. Therefore, the one-side end portion 12a functions to scoop up dust which might intrude from the outside, thereby to prevent the intrusion of the dust from the outside. Also, the groove contact margin is set to make the sliding resistance proper so that the sliding resistance is maintained properly.

Furthermore, since the sealing lip 13 is bent in the direction opposed to the moving direction of the nut 4, it the sealing lip 13 may function to gather up the dust intruded from the outside. However, a wide contacting area is formed such that the entire side surface on the side of the shaft track groove 3 makes sliding contact with the front arc surface 3b. Therefore, the sealing lip 13 can prevent the intrusion of the dust from the outside. At the same time, the sealing lip 13 is made of the flake member so that its rigidity is low enough to suppress the sliding resistance substantially equivalent to a sliding resistance caused by the groove contact margin of the groove sliding contact portion 12 on which the sealing lip 13 is provided.

When the nut 4 moves in the direction opposed to the moving direction as shown in FIG. 3, the seal member 7 of the mirror image, which is mounted on the back end portion of the nut 4, is positioned at the front. Therefore, the intrusion of the dust from the outside can be prevented like above described while the sliding resistance being maintained properly.

According to the embodiment, as has been described hereinbefore, due to the sealing lip which is disposed as the flake member on the side where the groove sliding contact portion of the sealing member makes sliding contact with the front arc surface of the shaft track groove. The intrusion of the dust from the outside is prevented by forming the wide contact area on the groove sliding contact portion which intrinsically functions to gather up the dust from the outside. At the same time, the sliding resistance can be suppressed substantially equivalent to that caused by the groove sliding contact portion. Accordingly, the dust resistance to the outside dust can be improved while properly maintaining the sliding resistance caused by the seal member.

[Embodiment 2]

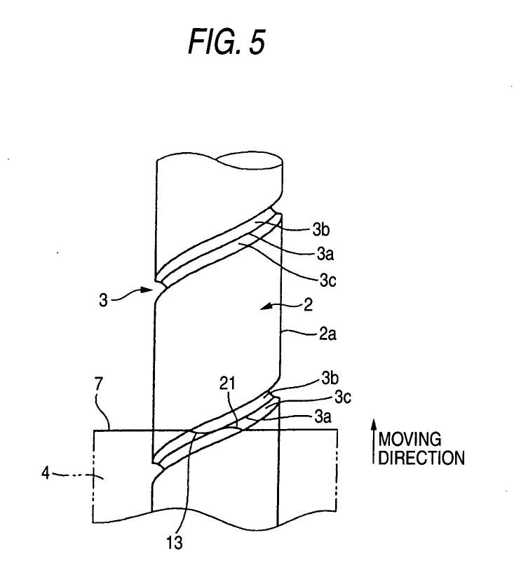

FIG. 4 is a view showing a seal member of second embodiment and taken in the direction of arrow A. FIG. 5 is an explanatory view showing a sliding contact state of a groove sliding contact portion of the seal member on the front side of the moving direction of Second embodiment.

Here, the description of portions similar to those of first embodiment is omitted by designating them by the identical numerals.

In FIG. 4, numeral 21 designates a sealing lip 21 formed at the groove sliding contact portion 12 and arranged on the other side of the sealing lip 13. This sealing lip 21 is a substantially arc flake member. The sealing lip 21 is formed on the opposite side of the front arc surface 3b of the shaft track groove 3 across the groove bottom center 3a, i.e., on the side to make sliding contact with the back arc surface 3c located on the back side of the moving direction of the nut 4, as shown in FIG. 5. When the nut 4 indicated by double-dotted lines in FIG. 5 is screwed on the grooved shaft 2, the sealing lip 21 is bent along the slope of the back arc surface 3c backward of the nut 4, i.e., in the moving direction so that its entire side surface on the side of the shaft track groove 3 comes into sliding contact with the back arc surface 3c.

Next, the operations of the above described construction are explained.

The nut 4 having the seal members 7 of the embodiment mounted thereon is screwed on the grooved shaft 2 through the balls 6. When the nut 4 is moved, the one-side end portion 12a of the groove sliding contact portion 12 of the seal member 7 mounted on the front end portion in the moving direction of the nut 4 is bent in the moving direction of the nut 4 so that it moves while the entire side face on the side of the shaft track groove 3 making sliding contact with the back arc surface 3c.

The sealing lip 13 moves in the moving direction while its entire side surface on the side of the shaft track groove 3 making sliding contact with the front arc surface 3b like first embodiment.

At this time, the sealing lip 21 of the groove sliding contact portion 12 is bent in the moving direction of the nut 4. Further, the wide contact area is formed such that the entire side surface, which is the side of shaft track groove 3, of the sealing lip 21 sliding contact with the back arc surface 3c. Therefore, the sealing lip 21 acts to scoop up the dust, thereby to prevent the intrusion of the dust from the outside further. At the same time, the sealing lip 21 is a flake member having a low rigidity so that the sliding resistance can be suppressed substantially equivalent to the resistance caused by the groove contact margin of the groove sliding contact portion 12 having the sealing lip 21. The operations of the sealing lip 13 are similar to those of the first embodiment.

In the groove sliding contact portion 12 of the seal member 7 mounted on the rear end portion in the moving direction of the nut 4, the sealing lip 13 and the sealing lip 21 of the groove sliding contact portion 12 are bent like the aforementioned front end portion at the back end portion of the nut 4, and move in the moving direction.

At this time, the sealing lip 21 of the groove sliding contact portion 12 is bent in the moving direction of the nut 4, and the entire side surface on the side of the shaft track groove 3 makes sliding contact with the back arc surface 3c to form the wide contact area. As a result, the sealing lip 21 functions to scoop up the lubricant, which might otherwise leak out of the inside, thereby to prevent the leakage of the lubricant from the inside.

Further, since the sealing lip 13 is bent in the direction opposed to the moving direction of the nut 4, the sealing lip 13 may function to gather up the lubricant from the inside. A wide area is formed such that the entire side face on the side of the shaft track groove 3 makes sliding contact with the front arc surface 3b. Therefore, the sealing lip 13 can prevent the leakage of the lubricant from the inside.

Here, the sliding resistance can be suppressed, like the case of the front end portion, substantially equivalent to the resistance caused by the groove contact margin of the groove sliding contact portion 12.

In the case that the nut 4 moves backward of the moving direction shown in FIG. 5, the operations of the sealing lip 13 and the sealing lip 21 are reversed. However, the sealing lips 13, 21 still likewise prevent the intrusion of the dust from the outside and the leakage of the lubricant from the inside.

In the second embodiment, as has been described hereinbefore, in addition to the effects like those of first embodiment, the sealing portion is also provided as the flake member on the back arc surface of the shaft track groove of the groove sliding contact portion of the seal member. As a result, a wide contact area can be formed on the groove sliding contact portion on the side of the back arc surface having the intrinsic action to scoop in the lubricant from the inside thereby to prevent the leakage of the lubricant from the inside while keeping the sliding resistance proper. In addition, the wide contact areas can be formed on the groove sliding contact portions of both the front arc surface and the back arc surface. Therefore, the seal member can prevent both the intrusion of the dust from the outside and the leakage of the lubricant from the inside while maintaining the sliding resistance properly.

Here, the present embodiments have been described on the case, in which the invention is applied to the ball screw apparatus using the circulation method of a return tube type. However, the circulation method should not be limited thereto, but similar effects can be attained even if the invention is applied to a ball screw apparatus of a circulation method using a top, a diffract type, an end cap or the like.

Moreover, the embodiments have been described with an assumption that the grooved shaft of the ball screw apparatus is turned to move the nut in the axial direction. However, similar effects can be attained even if the invention is applied to the ball screw of the type, in which the nut is turned while the grooved shaft is fixed.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

1. A ball screw apparatus comprising:
a screw shaft having an outer peripheral surface on which a shaft track groove is formed so as to helically extend along with a longitudinal direction thereof;
a nut being capable of moving along with the screw shaft, the nut having front and back end portions and an inner peripheral surface on which a nut track groove is formed so as to oppose to the shaft track groove; and
a seal member provided on each of the front and back end portions of the nut, the seal member including:
a substantially arc-shaped groove sliding contact portion provided on the seal member so as to sliding contact with the shaft track groove, the groove sliding contact portion having:
a first sealing lip formed on a first outer peripheral of the groove sliding contact portion so as to sliding contact with a first inner surface of the shaft track groove which is defined between a groove bottom center of the shaft track groove and an edge of the shaft track groove which is located on a front-side of the moving direction of the nut
wherein the first sealing lip projects to a screw shaft side rather than the groove sliding contact portion.

2. The ball screw apparatus according to claim 1,
wherein a second sealing lip is formed on a back-side peripheral of the groove sliding contact portion so as to contact with a second inner surface of the shaft track groove which is defined between a groove bottom center of the shaft track groove and an edge of the shaft track groove which is located on a back-side of the moving direction of the nut.

3. The ball screw apparatus according to claim 1, wherein the sealing member including:
an outer peripheral surface sliding contact portion which contacts with an outer peripheral surface of the screw shaft.

4. The ball screw apparatus according to claim 1, wherein a substantially entire side surface of the sealing lip sliding contacts with the shaft track groove.

5. The ball screw apparatus according to claim 1, wherein the shaft track groove is substantially arc shaped in a sectional view.

6. The ball screw apparatus according to claim 1, wherein the groove sliding contact portion is substantially arc shaped.

7. The ball screw apparatus according to claim 1, wherein the sealing lip is substantially arc shaped.

8. The ball screw apparatus according to claim 1, wherein the seal member is disposed perpendicular to a longitudinal axis of the screw shaft.

9. The ball screw apparatus according to claim 1, wherein the seal member is made of-elastic material.

10. The ball screw apparatus according to claim 2, wherein the first sealing lip bends backwardly, and
the second sealing lip bends forwardly.

11. The ball screw apparatus according to claim 2, wherein the first and second sealing lips bend in opposite direction mutually.
